(19) United States
(12) Patent Application Publication
(10) Pub. No.: US 2026/0271893 A1
(43) Pub. Date: Sep. 17, 2026

(54) MULTI-STAGED CASCADING THERMOELECTRIC COOLING SYSTEM FOR USE IN A FROZEN FISH FOOD FEEDING APPARATUS

(71) Applicant: Manta Systems, LLC, Rockwall, TX (US)

(72) Inventors: Tamara R. Marshall, Rockwall, TX (US); Kevin S. Hodge, Allen, TX (US); Douglas N. Laube, Farmersville, TX (US); Joshua A. Laube, Wylie, TX (US)

(21) Appl. No.: 19/566,618

(22) Filed: Mar. 13, 2026

Related U.S. Application Data
(60) Provisional application No. 63/771,446, filed on Mar. 13, 2025.

(51) Int. Cl. A01K 61/85; F25B 21/02

(52) U.S. Cl. CPC A01K 61/85; F25B 21/02; F25B 2321/023; F25B 2321/0251

(57) ABSTRACT

A system may include a frozen fish food feeding apparatus with a cooling system and a feeding mechanism. The cooling system may include a first thermoelectric cooling device coupled to a second thermoelectric cooling device. The feeding mechanism may include a plurality of columns, each column structured to store a plurality of vertically stacked frozen fish food cubes and having a slot for the frozen fish food cubes to pass through. The feeding mechanism may further include a rotatable carousel rack housing the plurality of columns and operable to selectively rotate each column to a dispensing position in which the slot in the column is aligned with a plunger and a swinging food door. The plunger is operable to expel the frozen fish food cubes in the column in the dispensing position one at a time through the aligned slot and through the swinging food door into a fish tank.

### CROSS-REFERENCE TO RELATED APPLICATIONS

This application claims priority to and the benefit of U.S. Provisional Patent Application Ser. No. 63/771,446, filed Mar. 13, 2025, entitled “Multi-Staged Cascading Thermoelectric Cooling System for Use in a Frozen Fish Food Feeding Apparatus”, which is incorporated by reference herein in its entirety.

### TECHNICAL FIELD

The present disclosure relates to a thermoelectric cooling (TEC) system, and more particularly, to a multi-staged, cascading TEC system operable to achieve sub-freezing temperatures. In some implementations, the thermoelectric cooling system may be employed in a frozen fish food feeding apparatus or other industrial applications.

### BACKGROUND

Thermoelectric coolers (TECs) are widely used for temperature management in applications requiring precise cooling, such as electronics, medical devices, and refrigeration. Conventional TEC systems have limited capacity and efficiency when attempting to reach freezing temperatures (0° Celsius and below), particularly in compact, low-power applications.

### SUMMARY

The present disclosure is directed to multi-staged, cascading thermoelectric cooling (TEC) systems and associated methods for achieving sub-freezing temperatures. In some implementations, the thermoelectric cooling system may be employed in a frozen fish food feeding apparatus or other industrial applications.

The details of one or more implementations of the systems and methods are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a perspective view of an implementation of a multi-staged cascading TEC assembly, the main component of a thermoelectric cooling system, according to the present disclosure.

FIG. 2 illustrates a perspective view of a frozen fish food feeding apparatus, depicting one application of the thermoelectric cooling system, according to the present disclosure.

FIG. 3 illustrates a front view of the frozen fish food feeding apparatus of FIG. 2, according to the present disclosure.

FIG. 4 illustrates a back view of the frozen fish food feeding apparatus of FIG. 2, according to the present disclosure.

FIG. 5 illustrates a top view of the frozen fish food feeding apparatus of FIG. 2, according to the present disclosure.

FIG. 6 illustrates a bottom view of the frozen fish food feeding apparatus of FIG. 2, according to the present disclosure.

FIG. 7 illustrates a left side view of the frozen fish food feeding apparatus of FIG. 2, according to the present disclosure.

FIG. 8 illustrates a right side view of the frozen fish food feeding apparatus of FIG. 2, according to the present disclosure.

FIG. 9 illustrates a cross-sectional plan view of FIG. 8, according to the present disclosure.

FIG. 10 illustrates an isometric cross-sectional view of FIG. 8, according to the present disclosure.

FIG. 11 illustrates an expanded view of the components comprising the frozen fish food feeding apparatus of FIG. 2, according to the present disclosure.

FIG. 12 illustrates an implementation of a method of dispensing a frozen fish food cube from a computer-controlled frozen fish food feeding apparatus, according to the present disclosure.

FIG. 13 illustrates a screenshot of a login page from a representative mobile device application that may be used to control the frozen fish food feeding apparatus, according to the present disclosure.

FIG. 14 illustrates a screenshot of a home page from a representative mobile device app application that may be used to control the frozen fish food feeding apparatus, according to the present disclosure.

FIG. 15 illustrates a screenshot of a scheduling page from a representative mobile device application that may be used to control the frozen fish food feeding apparatus, according to the present disclosure.

FIG. 16 illustrates a screenshot of a temperature page from a representative mobile device application that may be used to control the frozen fish food feeding apparatus, according to the present disclosure.

FIG. 17 illustrates a screenshot of a user device page from a representative mobile device application that may be used to control the frozen fish food feeding apparatus, according to the present disclosure.

FIG. 18 illustrates a screenshot of a menu page from a representative mobile device application that may be used to control the frozen fish food feeding apparatus, according to the present disclosure.

FIG. 19 illustrates a screenshot of a profile page from a representative mobile device application that may be used to control the frozen fish food feeding apparatus, according to the present disclosure.

Like reference symbols in the various drawings indicate like elements.

### DETAILED DESCRIPTION

The present disclosure is directed to a thermoelectric cooling system (hereinafter “cooling system”) and associated methods for achieving sub-freezing temperatures. In the present disclosure, the cooling system is being discussed infra with respect to a particular application—a frozen fish food feeding apparatus. Many other applications of the cooling system are possible however, including medical, military, and consumer applications.

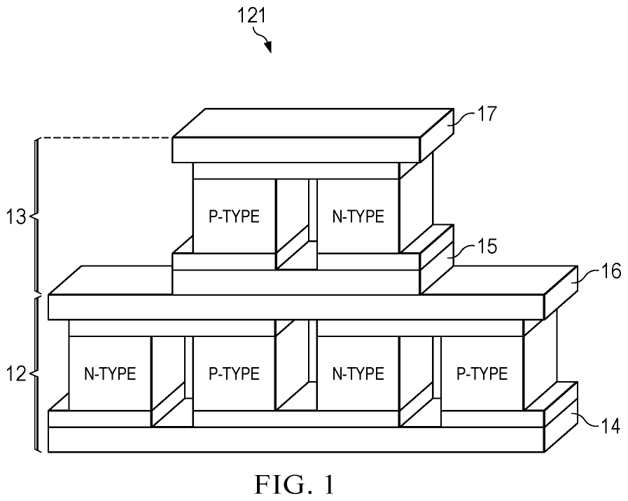

Referring now to the drawings, where like reference numerals represent like components, FIG. 1 illustrates a perspective view of a multi-staged cascading TEC assembly 121 (hereinafter “TEC assembly”), the main component of a thermoelectric cooling system 10 (discussed in further detail and shown infra). In some implementations, the TEC assembly 121 comprises a first-stage TEC module 12 thermally coupled to a second-stage TEC module 13. The first-stage and the second-stage TEC modules 12, 13 may be thermally coupled by a thermal interface layer, such as thermal paste (not shown). In some implementations, the first-stage TEC module 12 is larger than the second-stage TEC module 13. In other implementations, the first-stage TEC module 12 and the second-stage TEC module 13 are substantially the same size.

The first-stage TEC module 12 comprises one or more pairs of n-type and p-type semiconductors (each pair known as a “couple”) connected electrically in a series and thermally in parallel. The one or more couples are first soldered to a metal interconnect, such as copper, and then to thermally conducting plates, such as ceramic plates. As depicted in FIG. 1, the first-stage TEC module 12 comprises a first ceramic plate 14 and a second ceramic plate 16. In the present disclosure, the first ceramic plate 14 is the “hot” side and the second ceramic plate 16 is the “cold” side of the first-stage TEC module 12. Leading wires (not shown) are used to connect the TEC assembly 121 to a power supply.

Like the first-stage TEC module 12, the second-stage TEC module 13 comprises one or more pairs of n-type and p-type semiconductors connected electrically in a series and thermally in parallel. The one or more couples are first soldered to a metal interconnect, such as copper, and then to thermally conducting plates, such as ceramic plates. The second-stage TEC module 13 comprises a first ceramic plate 15 and a second ceramic plate 17. In the present disclosure, the first ceramic plate 15 is the “hot” side and the second ceramic plate 17 is the “cold” side of the second-stage TEC module 13. As depicted in FIG. 1, the “hot” side of the second-stage TEC module 13 thermally couples to the “cold” side of the first-stage TEC module 12.

The TEC assembly 121 operates by the Peltier effect. Application of an electric current to the TEC assembly 121 causes heat to move through the TEC assembly 121 from one side to the other, creating a temperature differential. The first-stage TEC module 12 provides the first level of cooling and removes bulk heat from the TEC assembly 121. The “cold” side of the first-stage TEC module 12 absorbs and transfers heat to the “hot” side of the first-stage TEC module 12. The second-stage TEC module 13 operates in substantially the same manner; however, the multi-staged cascading structure of the TEC assembly 121 amplifies the cooling effect. In more detail, the second-stage TEC module 13 takes the pre-cooled surface from the first-stage TEC module 12, further lowering the temperature of the “cold” side of the second-stage TEC module 13 to sub-freezing levels.

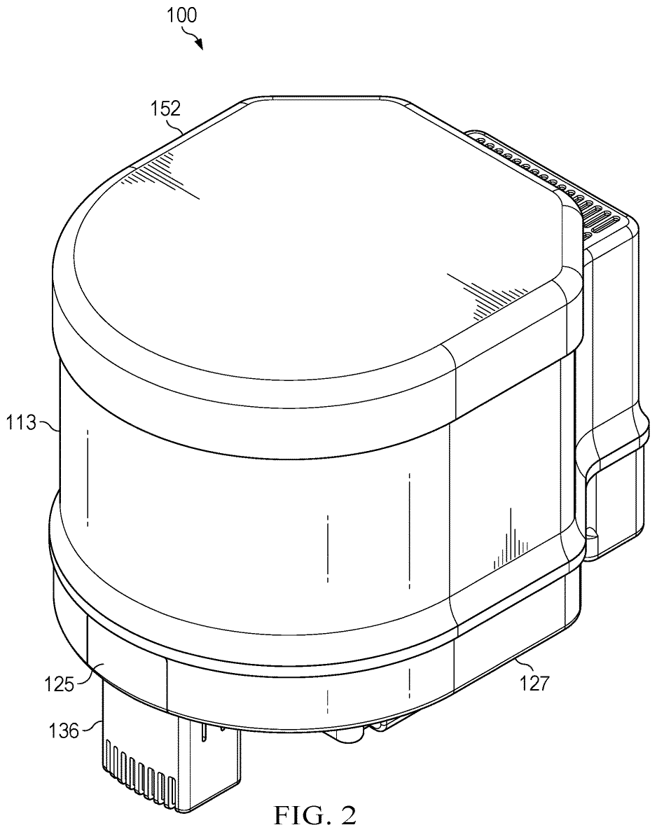

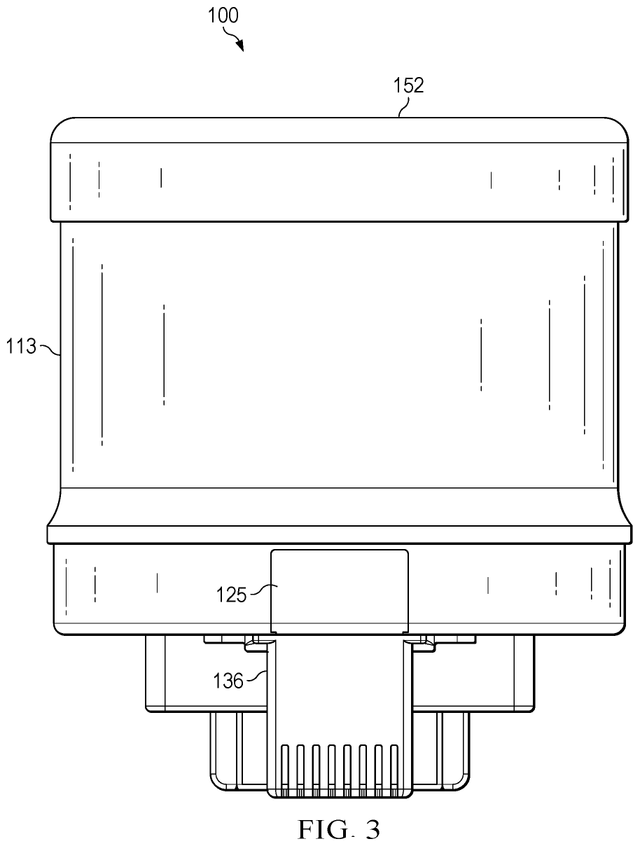

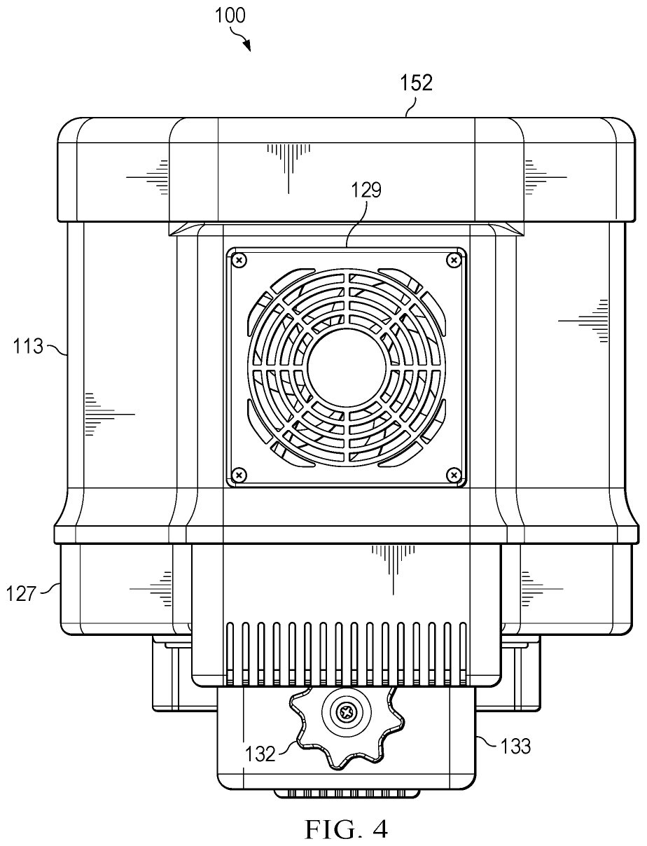

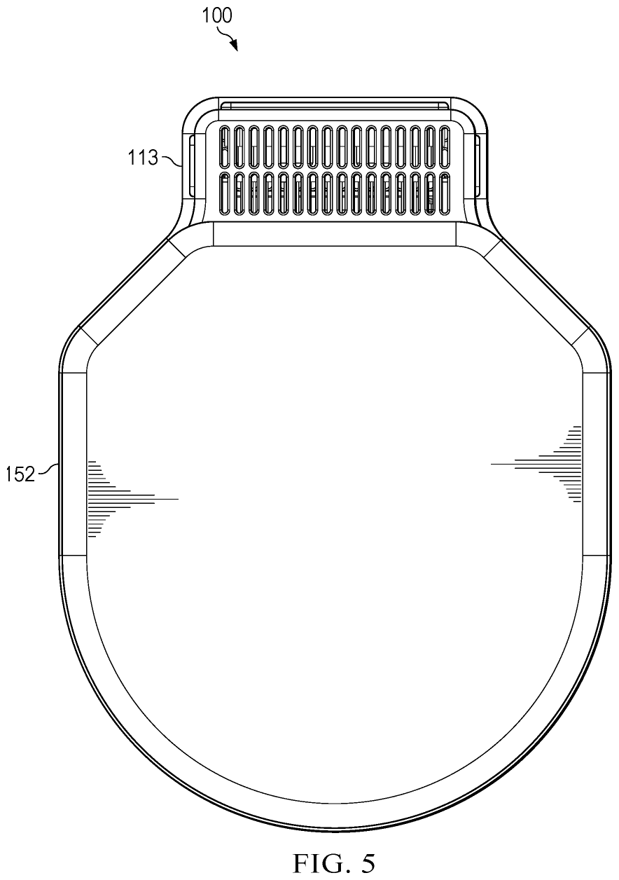

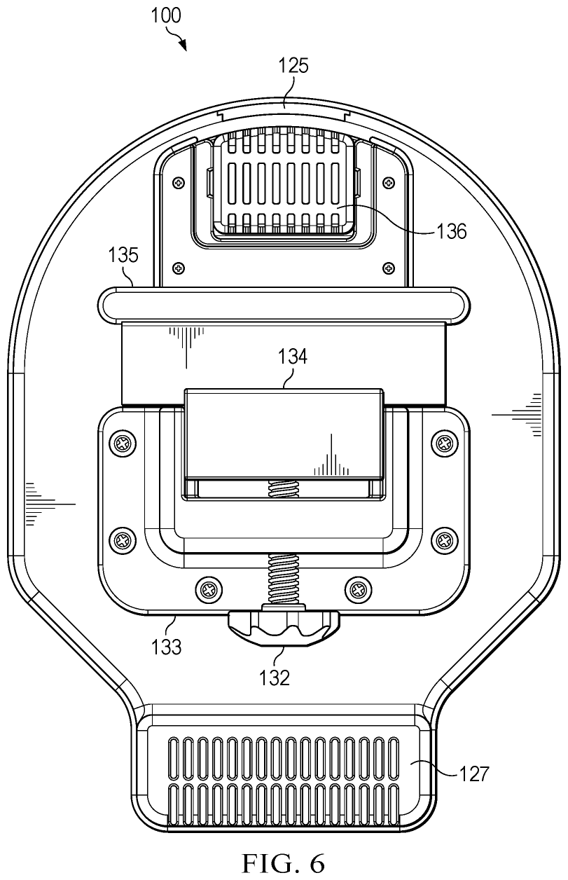

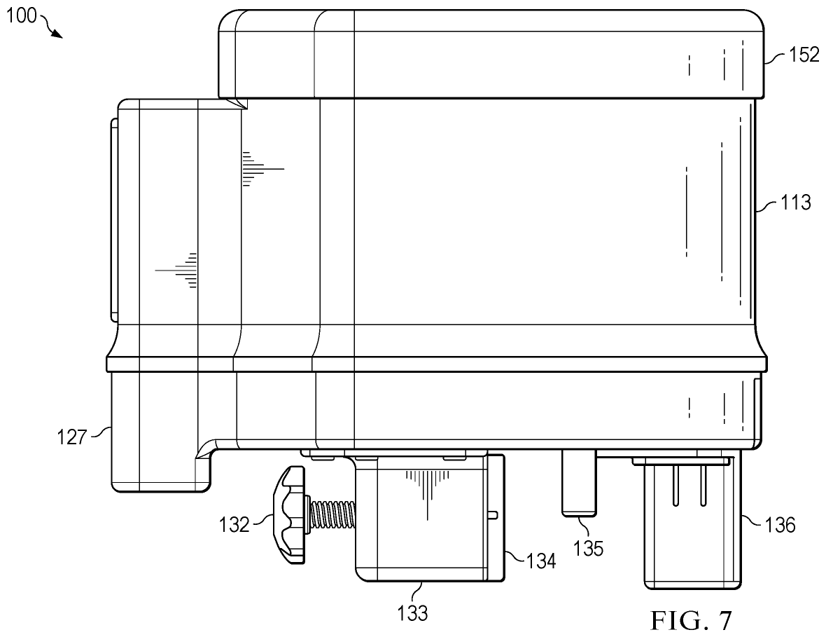

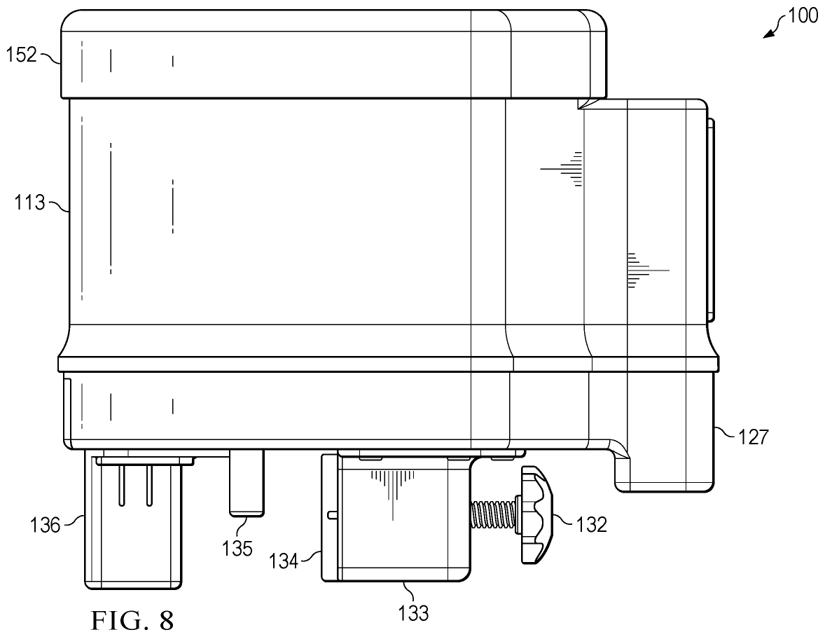

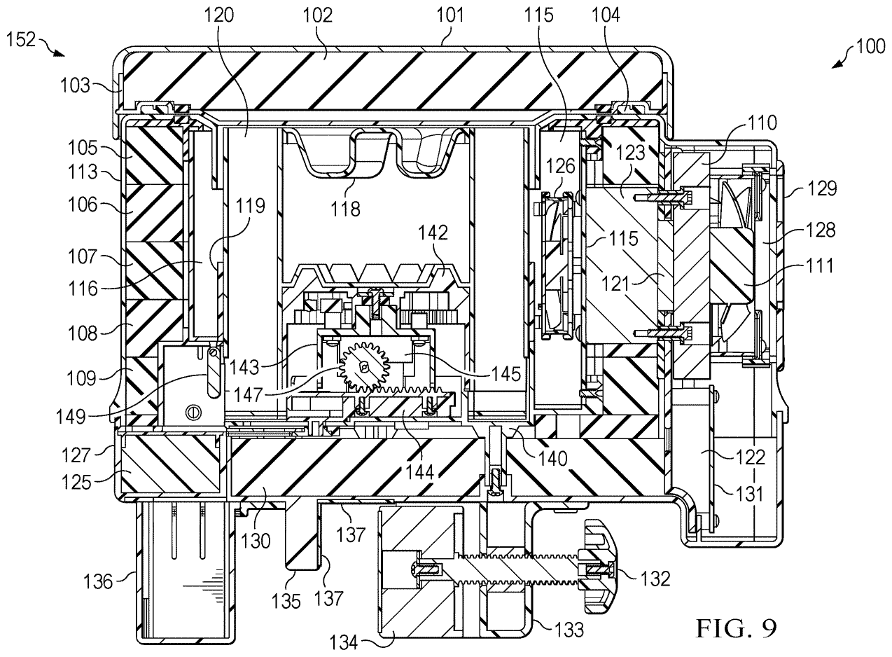

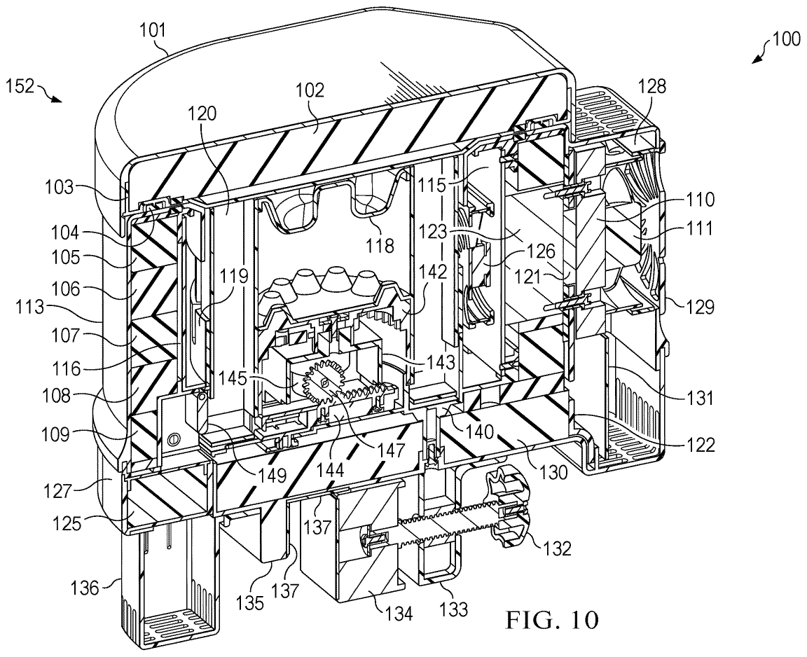

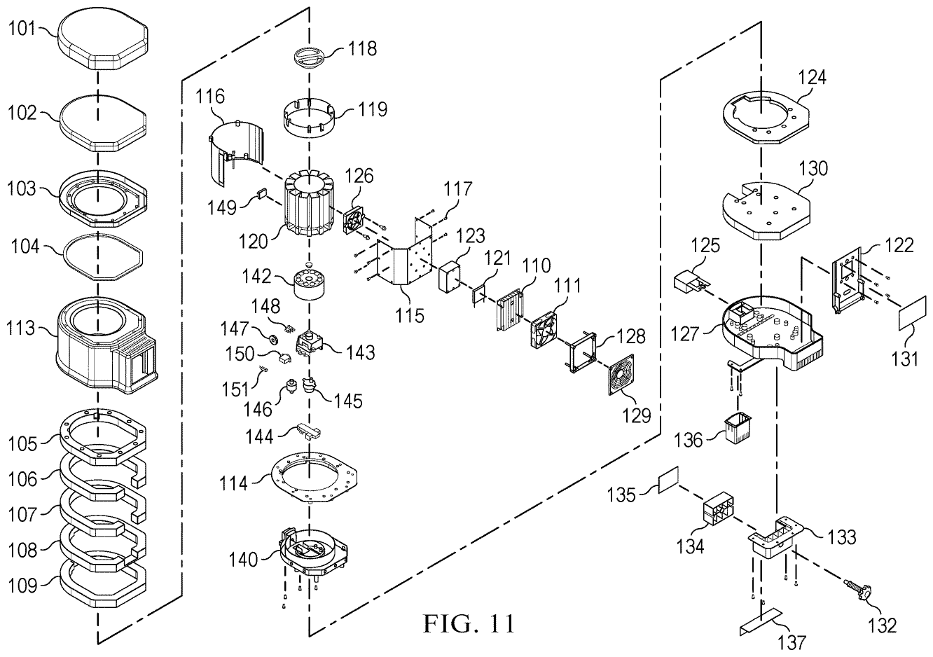

One application of the cooling system 10 of the present disclosure may be seen in FIGS. 2 through 11, which depict an implementation of the cooling system 10 in the context of a frozen fish food feeding apparatus 100 (hereinafter “fish feeding apparatus”). FIGS. 2 through 8 illustrate a perspective view, front view, back view, top view, bottom view, left side view, and right side view, respectively, of the fish feeding apparatus 100. FIGS. 9 and 10 illustrate a cross-sectional plan view and an isometric cross-sectional view of FIG. 8. FIG. 11 illustrates an expanded view of the components comprising the fish feeding apparatus 100. For most of the discussion that follows, the component parts of the fish feeding apparatus 100 are best seen in the cross-sectional views in FIGS. 9, 10 and the expanded view in FIG. 11.

The fish feeding apparatus 100 comprises the cooling system 10 and a feeding mechanism 30 disposed within a housing. The housing of the fish feeding apparatus 100 comprises a removeable lid 152, a housing body 113, and a bottom plate 127. The lid 152 comprises lid insulation 102 situated between an exterior lid portion 101 and an interior lid portion 103. The interior lid portion 103 may comprise one or more magnets for purposes of removing or attaching the lid 152 to the housing body 113.

The housing body 113 comprises a lid gasket 104 and molding 105 that may hold one or more magnets to secure the lid 152. In some implementations, the housing body 113 may further comprise insulation, such as stacked insulation layers 106, 107, 108, 109. In other implementations, the housing body 113 may comprise foam insulation. The housing body 113 couples to a bottom plate 127. The bottom plate 127 may comprise insulation 130, which may be secured by bottom plate cover 124.

Several fish tank attachments couple to the exterior of the bottom plate 127, including a bottom mounting bracket 133, a mounting component 134, and a tank component 135. The mounting component 134 may have a rubber lining 137 on its interior surface. A knob and screw assembly 132 couples the bottom mounting bracket 133 and the mounting component 134. The knob and screw assembly 132 may be operable to increase or decrease the distance between the mounting component 134 and the tank component 135.

When a user mounts the fish feeding apparatus 100 to a fish tank or aquarium, the tank component 135 will sit inside the tank, which houses aquatic life and is filled with freshwater or saltwater. To securely mount the fish feeding apparatus 100 to a fish tank, a user may insert the tank wall between the mounting component 134 and the tank component 135 such that the tank component 135 engages the tank wall. The user may then adjust the knob and screw assembly 132 until both the mounting component 134 and the tank component 135 engage opposing sides of the tank wall.

FIGS. 9 and 10 show the cooling system 10 situated within the housing body 113. As described supra with respect to FIG. 1, the TEC assembly 121 is the main component of the cooling system 10. The cooling system 10 further comprises a freezer assembly embedded within the housing body 113. As best seen in FIG. 11, the freezer assembly comprises an interior plate 114, freezer lining 115 and 116, and a bottom plate 140. The components of the freezer assembly may be coupled via screws 117. Each of the components of the freezer assembly may be made of thermally conductive material, such as aluminum. In some implementations, the freezer lining 116 may be made of plastic.

As best depicted in FIGS. 9 and 10, the cooling system 10 may further comprise an external fan 111 coupled to a heat dissipater or heat sink 110. A bracket 128 may couple the external fan 111 to the heat sink 110, and a fan guard 129 may couple to the exterior of the bracket 128. In some implementations, the heat sink 110 may be made of aluminum or other similar materials. The heat sink 110 may couple to the “hot” side of the first-stage TEC module 12 of the TEC assembly 121, which may be housed within a TEC module housing 122. The “cold” side of the second-stage TEC module 13 of the TEC assembly 121 may couple to a thermal block 123. In some implementations, the thermal block 123 may be made of aluminum or another thermally conductive material. The thermal block 123 may couple to an exterior portion of the thermally conductive freezer lining 115. An internal fan 126 may couple to an interior portion of the thermally conductive freezer lining 115.

The cooling system 10 may be monitored by one or more temperature sensors (not shown). In some implementations, the cooling system 10 may be monitored by temperature sensors for the freezer assembly, the TEC assembly 121, and the exterior fan 111. The cooling system 10 may be designed to achieve sub-freezing temperatures and in an implementation, the target temperature to be reached and maintained is approximately −11° Celsius. The inventors of the present disclosure conducted extensive testing to determine the relative size of the first-stage TEC module 12 to the second-stage TEC module 13 that would achieve this target temperature and through such testing determined that one operable TEC assembly 121 comprises a first-stage TEC module 12 of at least 40 mm coupled to a 30 mm second-stage TEC module 13. Other combinations may be suitable depending on the size of the fish feeding apparatus and/or intended target temperature. With a TEC assembly 121 comprising a 40 mm first-stage TEC module 12 and a 30 mm second-stage TEC module 13, the cooling system 10 may cool to 0° Celsius in approximately thirty (30) minutes and may cool to −11° Celsius in approximately two (2) hours.

The inventors of the present disclosure further tested a TEC assembly 121 having a first-stage TEC module 12 and a second-stage TEC module 13 of substantially the same size. For example, the inventors determined that another operable TEC assembly 121 comprises a first-stage TEC module 12 of at least 40 mm coupled to a 40 mm second-stage TEC module 13. With a TEC assembly 121 comprising a 40 mm first-stage TEC module 12 and a 40 mm second-stage TEC module 13, the cooling system 10 may cool to 0° Celsius in approximately thirty (30) minutes and may cool to −11° Celsius in approximately two (2) hours.

The inventors also determined that yet another operable TEC assembly 121 comprises a first-stage TEC module 12 of at least 50 mm coupled to a 50 mm second-stage TEC module 13. With a TEC assembly 121 comprising a 50 mm first-stage TEC module 12 and a 50 mm second-stage TEC module 13, the cooling system 10 may cool to 0° Celsius in approximately thirty (30) minutes and may cool to −11° Celsius in approximately two (2) hours.

The performance described above reflects repeated internal testing conducted by the inventors under ambient indoor conditions representative of typical consumer environments. Cooling times and achievable temperatures may vary depending on factors such as enclosure size, insulation characteristics, airflow, ambient temperature, and power input.

In operation, the TEC assembly 121 drives the cooling system 10 to achieve sub-freezing temperatures for purposes of maintaining frozen fish food cubes in the housing until dispensed. As described supra with respect to FIG. 1, applying current to the TEC assembly 121 generates a temperature differential due to the Peltier effect. The first-stage TEC module 12 provides the first level of cooling and removes bulk heat from the TEC assembly 121. The “cold” side of the first-stage TEC module 12 absorbs and transfers heat to the “hot” side of the first-stage TEC module 12. The heat sink 110 coupled to the “hot” side of the first-stage TEC module further facilitates heat dissipation. The second-stage TEC module 13 takes the pre-cooled surface from the first-stage TEC module 12, further lowering the temperature of the “cold” side of the second-stage TEC module 13 to sub-freezing levels. The “cold” side of the second-stage TEC module 13 of the TEC assembly 121 cools the thermal block 123, which in turn cools the freezer lining 115. The internal fan 126, which may be coupled to the interior portion of the freezer lining 115, then pushes cool air to the sides of the freezer assembly. The external fan 111 cools the heat sink 110 and pushes warm air out of the fish feeding apparatus 100.

The feeding mechanism 30 is configured to store and dispense frozen fish food cubes from the fish feeding apparatus 100 into a fish tank or aquarium. As best shown in FIGS. 9, 10, and 11, the frozen fish food storage component of the feeding mechanism 30 comprises a removable carousel rack 120. The carousel rack 120 may be housed within an open cavity of the housing body 113 of the fish feeding device 100. The carousel rack 120 may have a handle 118 for purposes of inserting and removing the carousel rack 120 from the housing body 113.

In some implementations, the carousel rack 120 may be substantially cylindrical with one or more columns or chambers disposed around its circumference configured to hold frozen fish food cubes. In some implementations, the carousel rack 120 may comprise twelve (12) columns or chambers capable of holding a maximum of seventy-two (72) frozen fish food cubes, with each column or chamber configured to hold up to six (6) frozen fish food cubes. In other implementations, the carousel rack 120 may be configured to hold a smaller or larger number of frozen fish food cubes. Near the bottom portion of the carousel rack 120, each of the one or more columns or chambers may have a slot or hole through which a frozen fish food cube may be expelled. The carousel rack 120 may further comprise a carousel ring 119 configured to slide up and down the exterior surface of the carousel rack 120. When the carousel rack 120 is removed from the housing body 113, the carousel ring 119 may slide to the bottom of the carousel rack 120, covering the one or more slots or holes through which frozen fish food cubes may be expelled. When the carousel rack 120 is placed into the housing body 113, the carousel ring 119 slides up the carousel rack 120, exposing the one or more slots or holes near the bottom of the carousel rack 120.

The interior of the carousel rack 120 may have a hollow center cavity within which a carousel gear 142 may fit. The carousel gear 142 may house a first motor body 145 and a micro servo motor 146. In operation, the motor body 145 turns the micro servo motor 146, which in turn rotates the carousel gear 142 and carousel rack 120. A motor frame 143 may sit beneath the motor body 145 and the micro servo motor 146. The motor frame 143 may house a second motor body 145, a plunger 144, and a gear 147. The second motor body 145 acts to rotate gear 147, which engages teeth on the plunger 144 to push and pull the plunger 144 as the gear 147 rotates. As the plunger 144 moves laterally, it exerts a force against a frozen fish food cube positioned in the slot or hole near the bottom of the carousel rack 120. This force causes the frozen fish food cube to be expelled through the slot or hole near the bottom of the carousel rack 120. When the plunger 144 expels a frozen fish food cube, the frozen fish food cube hits and pushes against a swinging food door 149, while a sliding drawer 125 simultaneously slides out of the bottom plate 127 to extend beyond the housing body 113, creating an open pathway to a food basket 136. When the frozen fish food cube passes through the open swinging food door 149, the sliding drawer 125 pops out of the bottom plate 127 to expose an opening into the food basket 136, allowing the frozen fish food cube to drop into the food basket 136. The food basket 136 has gaps through which water from the fish tank or aquarium may enter. When the frozen fish food cube drops into the food basket 136, it may begin to thaw, causing pieces of the fish food cube to disperse into the water through the gaps of the food basket 136.

The feeding mechanism 30 further comprises an optical emitter and sensor pair 150, 151 housed on opposite sides of the swinging food door 149, configured to emit a constant laser beam through this space. When the feeding mechanism 30 registers an optical break of the laser beam emitted by the optical emitter and sensor pair 150, 151, it indicates that a frozen fish food cube has passed through the swinging food door 149 and has successfully been dispensed into the food basket 136. If no optical break is detected by the feeding mechanism 30, then the feeding attempt has failed.

In some implementations, the cooling system 10 and the feeding mechanism 30 are both powered either independently or through one device. The power may be provided electrically, by batteries, solar panels, or other powering means.

In operation, the cooling system 10 freezes the freezer assembly disposed within the housing body 113, which houses the feeding mechanism 30 including the carousel 120, to keep stored fish food cubes frozen until dispensed. In some implementations, the cooling system 10 and the feeding mechanism 30 may be computer controlled. FIGS. 9, 10, and 11 depict a printed circuit board 131 housed within a front portion of the bottom plate 127 and to which the cooling system 10 and the feeding mechanism 30 are operably coupled. The printed circuit board 131 may include components that may enable transmission of signals through a wireless network. In some implementations, these components may enable transmission of signals via Bluetooth® or Wi-Fi. The computer-controlled fish feeding apparatus 100 allows a user to automatically or manually dispense frozen fish food cubes at appropriate times, while maintaining the fish food cubes in a frozen state until it is dispensed. The printed circuit board 131 may be programmed to receive signals from the temperature sensors and the optical emitter and sensor pair 150, 151. In some implementations, the printed circuit board 131 may be programmed to respond to temperature fluctuations, such as by sending alert signals if the temperature deviates from a designated range, shutting down the computer-controlled fish feeding apparatus 100 if the temperature remains outside a designated range for a predetermined duration, and other actions.

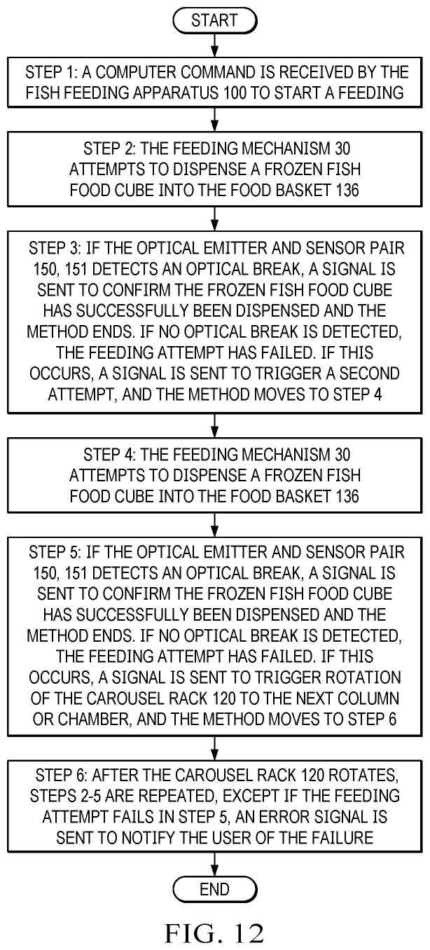

FIG. 12 depicts a flowchart of one method of feeding fish from the computer-controlled fish feeding apparatus 100. The method may comprise the following steps. In step 1, a computer command is received by the fish feeding apparatus 100 to start a feeding. In step 2, the feeding mechanism 30 attempts to dispense a frozen fish food cube into the food basket 136. In step 3, if the optical emitter and sensor pair 150, 151 detects an optical break, a signal is sent to confirm the frozen fish food cube has successfully been dispensed and the method ends. If no optical break is detected, the feeding attempt has failed. If this occurs, a signal is sent to trigger a second attempt, and the method moves to step 4.

In step 4, the feeding mechanism 30 attempts to dispense a frozen fish food cube into the food basket 136. In step 5, if the optical emitter and sensor pair 150, 151 detects an optical break, a signal is sent to confirm the frozen fish food cube has successfully been dispensed and the method ends. If no optical break is detected, the feeding attempt has failed. If this occurs, a signal is sent to trigger rotation of the carousel rack 120 to the next column or chamber, and the method moves to step 6. In step 6, after the carousel rack 120 rotates, steps 2-5 are repeated, except if the feeding attempt fails in step 5, an error signal is sent to notify the user of the failure.

In the foregoing method, some of the reasons the feeding attempts may fail include the following: one or more of the columns or chambers of the carousel rack 120 may be empty, a pair of frozen fish food cubes may be stuck together and cannot be dislodged from one another by the force of the plunger 144, or a malfunction may occur with respect to one or more of the components of the feeding mechanism 30.

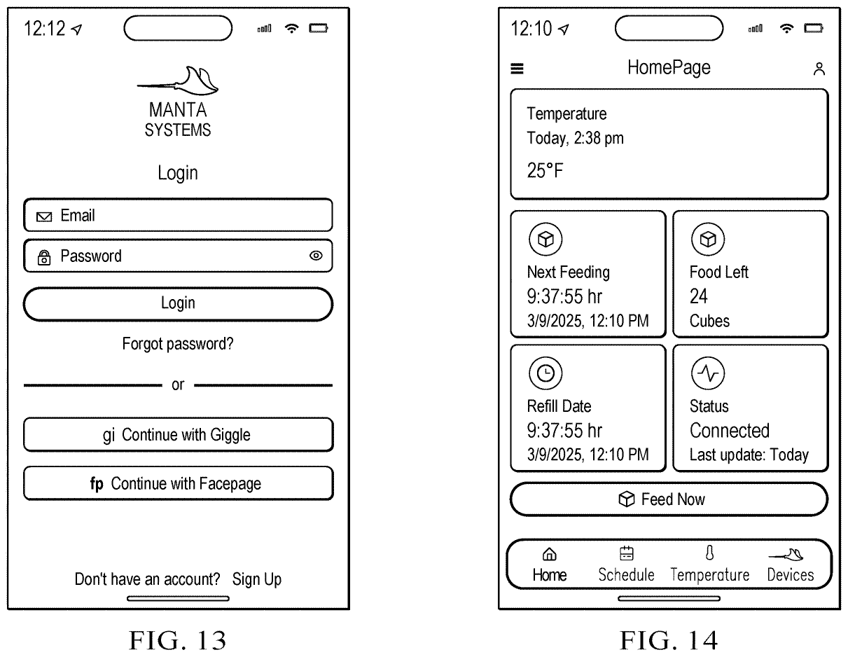

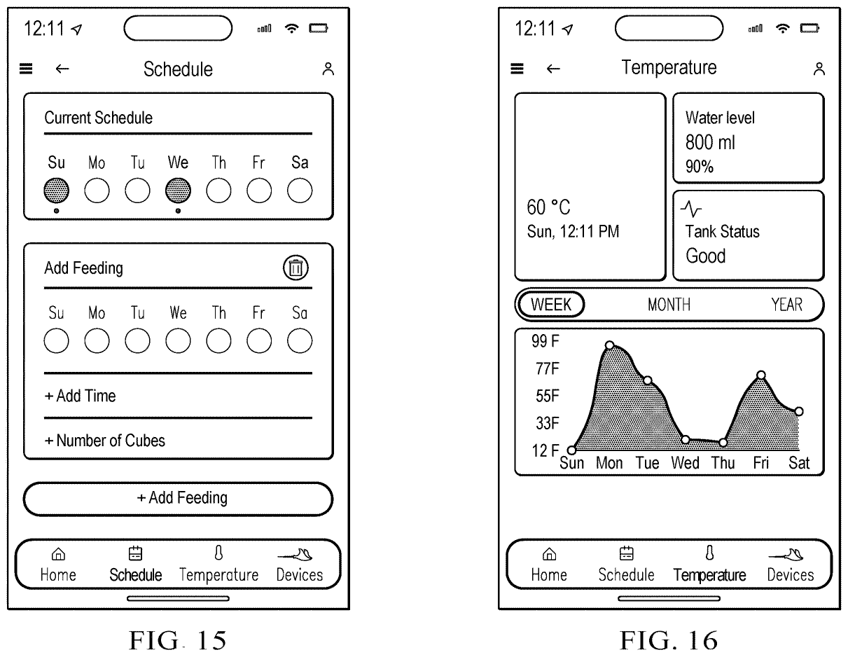

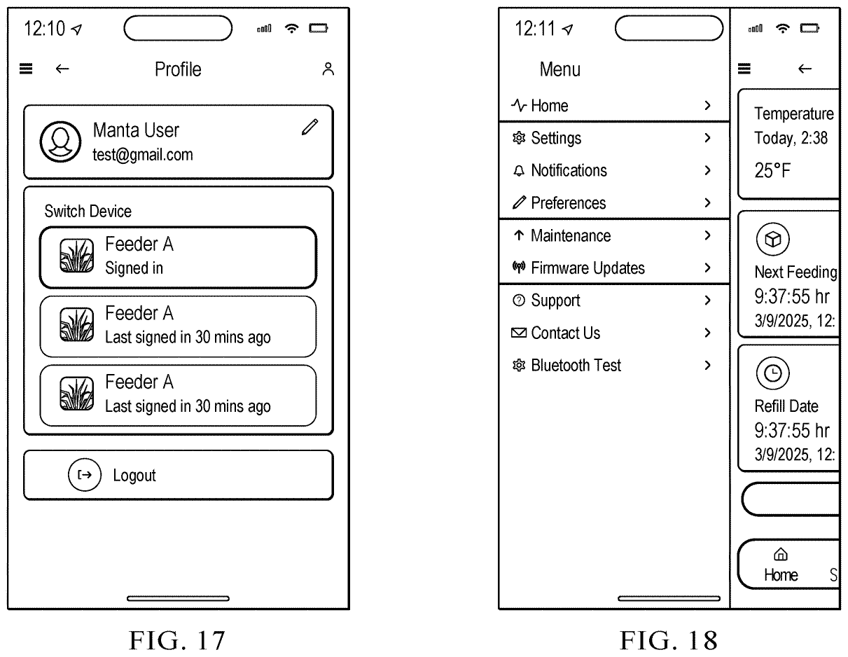

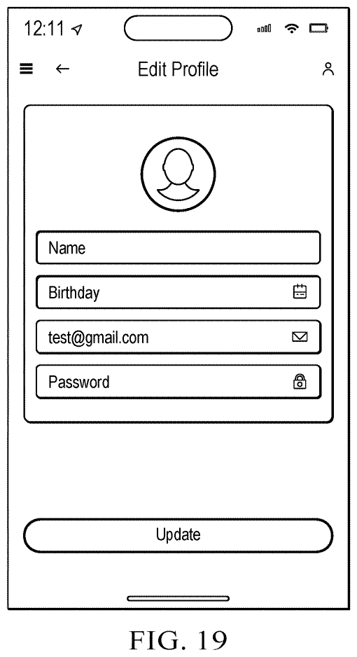

In some implementations, the computer-controlled fish feeding apparatus 100 may receive commands from a mobile device application (app), and the mobile device app may receive alerts and notifications from the computer-controlled fish feeding apparatus 100. FIGS. 13 to 19 depict screenshots from a representative mobile device app that may be used to control the fish feeding apparatus 100. FIG. 13 depicts a login page where a user may create a user profile on the app that is associated with at least one fish feeding apparatus 100. FIG. 14 depicts a home page where a user may view the temperature of the fish feeding apparatus 100, the time remaining until the next scheduled feeding, the number of frozen fish food cubes remaining in the carousel rack 120, a refill date, and the operating status of the fish feeding apparatus 100. The mobile device app allows a user to program automated feedings or manually instruct the fish feeding apparatus 100 to dispense frozen fish food cubes into the tank or aquarium. As shown in FIG. 14, from the home screen, a user may navigate to the scheduling page shown in FIG. 15, a temperature page shown in FIG. 16, a page displaying device(s) registered to a user profile shown in FIG. 17, a menu page shown in FIG. 18, and a profile page shown in FIG. 19.

It is to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system comprising:
a frozen fish food feeding apparatus comprising:
a cooling system comprising a first thermoelectric cooling device coupled to a second thermoelectric cooling device; and
a feeding mechanism comprising:
a plurality of columns, each column structured to store a plurality of vertically stacked frozen fish food cubes, and each column having a slot for the frozen fish food cubes to pass through;
a rotatable carousel rack housing the plurality of columns and operable to selectively rotate each column to a dispensing position in which the slot in the column is aligned with a plunger and a swinging food door; and
wherein the plunger is operable to expel the plurality of vertically stacked frozen fish food cubes in the column in the dispensing position one at a time through the aligned slot and through the swinging food door into a fish tank.

2. The system of claim 1, wherein the first thermoelectric cooling device and the second thermoelectric cooling device are substantially the same size.

3. The system of claim 1, wherein the first thermoelectric cooling device and the second thermoelectric cooling device are different sizes.

4. The system of claim 1, wherein the plurality of columns comprises between two and twelve columns.

5. The system of claim 1, wherein the rotatable carousel rack selectively rotates each column to the dispensing position via at least one motor.

6. The system of claim 1, wherein the plurality of frozen fish food cubes in each column is between two and six cubes.

7. The system of claim 1, wherein the cooling system comprises an air-cooled architecture.

8. The system of claim 1, wherein the cooling system further comprises at least one temperature sensor to monitor temperature and detect fluctuations within a pre-programmed range.

9. The system of claim 1, wherein the feeding mechanism further comprises at least one sensor to indicate when a frozen fish food cube has passed through the swinging food door.

10. A system comprising:
a computer-controlled frozen fish food feeding apparatus comprising:
a cooling system comprising a first thermoelectric cooling device coupled to a second thermoelectric cooling device, wherein the cooling system is structured to cool the apparatus to sub-freezing temperatures; and
a feeding mechanism structured to store a plurality of vertically stacked frozen fish food cubes; the feeding mechanism comprising a plunger operable to dispense one frozen fish food cube at a time into a fish tank.

11. The system of claim 10, wherein the cooling system further comprises:
at least one temperature sensor to monitor temperature and detect fluctuations within a pre-programmed range.

12. The system of claim 10, wherein the cooling system comprises an air-cooled architecture.

13. The system of claim 10, wherein the feeding mechanism further comprises:
a plurality of columns, each column structured to store a portion of the plurality of vertically stacked frozen fish food cubes, and each column having a slot for the frozen fish food cubes to pass through; and
a rotatable carousel rack housing the plurality of columns and operable to selectively rotate each column to a dispensing position in which the slot in the column is aligned with the plunger and a swinging food door that opens to the fish tank.

14. The system of claim 13, wherein the feeding mechanism further comprises at least one food dispensing sensor to indicate whether or not a frozen fish food cube has passed through the swinging food door into the fish tank.

15. The system of claim 10, wherein the computer-controlled frozen fish food feeding apparatus is operable to receive control signals from a mobile device application.

16. The system of claim 15, wherein the control signals are pre-programmed to automate dispensing one or more frozen fish food cubes into the fish tank on a schedule.

17. The system of claim 15, wherein the control signals are sent manually to instruct the apparatus to dispense a frozen fish food cube into the fish tank.

18. The system of claim 10, wherein the computer-controlled frozen fish food feeding apparatus is operable to send alerts and notifications to a mobile device application.

19. The system of claim 10, wherein a user may view information relating to the computer-controlled frozen fish food feeding apparatus on a mobile device application, wherein the information includes at least one of: a temperature of the apparatus, a quantity of time remaining until a scheduled feeding, a number of frozen fish food cubes remaining in the feeding mechanism, a refill date, and an operating status of the apparatus.

20. The system of claim 10, wherein the first thermoelectric cooling device and the second thermoelectric cooling device are substantially the same size.
